(19) United States
(12) Patent Application Publication
(10) Pub. No.: US 2005/0274585 A1
(43) Pub. Date: Dec. 15, 2005

(54) Freewheeling clutch

(75) Inventors: Frank Straub, Hohenroth (DE); Frieder Altmann, Pommersfelden (DE); Martin Halama, Weisendorf (DE)

Correspondence Address: OSTROLENK FABER GERB & SOFFEN, 1180 AVENUE OF THE AMERICAS, NEW YORK, NY, 100368403, US

(73) Assignee: INA-SCHAEFFLER KG

(21) Appl. No.: 11/144,106

(22) Filed: Jun. 3, 2005

(30) Foreign Application Priority Data
Jun. 12, 2004 (DE) 102004028669.8

(51) Int. Cl. F16D 41/07

(52) U.S. Cl. 192/45.1; 192/41 A

(57) ABSTRACT

A freewheeling clutch with clamping bodies arranged one behind another in the circumferential direction between a circular cylindrical inner ring and an outer ring concentric thereto. The clamping bodies are guided in pockets of a cage and are acted on by a band spring with spring tongues which bears radially against the cage. The band spring is annular and has punched cutouts arranged one behind another at spacings in the circumferential direction corresponding to the pockets of the cage and the spring tongues are formed by the cutouts. An empty pocket is arranged on the band spring between each two punched cutouts arranged one behind another in the circumferential direction.

### FIELD OF THE INVENTION

The invention relates to a freewheeling clutch with clamping bodies, which are arranged one behind another in the circumferential direction between a circular cylindrical inner ring and an outer ring concentric thereto, are guided in pockets of a cage and are acted on by a band spring with spring tongues which bears radially against the cage.

### BACKGROUND OF THE INVENTION

A freewheeling clutch of this kind is known from DE 1 142 254 B. The band spring used in that clutch is a punched-out, annularly curved, resiliently flexible metal sheet, which includes spring tongues connected to transverse webs via transverse folds bent in a U shape. In addition to the transverse fold of each spring tongue. There are transverse folds, which favor the spring action of this band spring but. Three transverse folds in each spring tongue region give the band spring a constructionally complicated form. The folds are designed on the two longitudinal webs interconnected by the transverse webs.

Such a freewheeling clutch additionally has a delimiting wall in each case inside a pocket for receiving a clamping body. The wall enables the clamping body to bear against the cage. This structure is known from U.S. Pat. No. 5,335,761. In that clutch, the pivoting of the clamping body brings about a deflection of the spring tongue until it bears against the cage over a surface. The clamping body then bears against the spring tongue over a surface and is supported on the cage via the tongue.

The spring tongues of the band springs of the previously known freewheeling clutches are each generally rectangular. They must be matched exactly to the respective shape of the clamping bodies to be used in order that the clamping bodies will be sufficiently sprung during operation. In one direction of rotation of the freewheeling clutch, the clamping bodies must be in frictional engagement with the clamping paths of the inner ring and of the outer ring. In the other direction of rotation, the clamping bodies must “lift off” when a corresponding centrifugal force arises, that is, lose contact with the inner ring. In designing the band spring, the width of the spring web which remains in each case between two adjacent cutouts of the band spring changes with the number of clamping bodies to be fitted. The more clamping bodies that are used, the thinner is the web. The web width also must be varied for different freewheel diameters. The known types of freewheeling clutch therefore have the disadvantage that the band spring has to be matched separately for each fitting with clamping bodies and for each diameter of the clamping bodies used in order that the clamping bodies may be sufficiently sprung and at a given rotational speed lose the contact with the inner ring acting as the inner clamping path owing to centrifugal force.

### SUMMARY OF THE INVENTION

The object of the invention is to produce a freewheeling clutch in which the same spring geometry can always be used with different fitting with clamping bodies. It is to be possible for such a geometry to be matched exactly once to the clamping bodies to be used and then to be used for any diameters or fitting arrangements of the freewheel. Previously, the spring geometry could only be developed experimentally in a very complicated way. It had to be determined anew for each variant of the clamping body number or quantity.

According to the invention, this object is achieved by arranging an empty pocket on the band spring between two punched cutouts arranged one behind another in the circumferential direction. In this connection, a number of empty pockets can also be provided, and an empty pocket can in each case be assigned to a punched cutout. A spring web holding the spring tongue is then formed between the punched cutout and the empty pocket. By using empty pockets of different size, which can be distributed symmetrically or asymmetrically on the band spring, the otherwise identical spring geometry can then always be used with different fitting of the freewheel with clamping bodies. The empty pockets can be made larger or smaller in the circumferential direction depending on how many clamping bodies are fitted into the freewheel.

With the invention, it is possible to achieve the advantage that the geometry of the spring webs and of the spring tongues always remains constant even with different clamping-body fitting, so that once a band spring geometry has been found, it can be retained for different designs.

Other features and advantages of the present invention will become apparent from the following description of the invention which refers to the accompanying drawings.

### BRIEF DESCRIPTION OF THE DRAWINGS

Illustrative embodiments of the invention are shown in the drawing and are described in greater detail below in comparison with a freewheeling clutch according to an older proposal of the applicant. In the drawing,

FIG. 1 shows a partial cross section through an older prior art freewheeling clutch;

FIG. 2 shows a perspective view of a cage of the prior art freewheeling clutch;

FIG. 3 shows a perspective view of a band spring of the prior art freewheeling clutch;

FIG. 4 shows a perspective view of a subassembly for the prior art freewheeling clutch consisting of the cage, the inserted band spring and clamping bodies mounted therein;

FIG. 5 shows the outside view of a portion of a band spring for a freewheeling clutch according to the invention, with a spring tongue arranged in the area of a punched cutout;

FIG. 6 shows a first embodiment of a portion of the band spring for a freewheeling clutch according to the invention;

FIG. 7 shows a second embodiment of a portion of the band spring for a freewheeling clutch according to the invention;

FIG. 8 shows a perspective view of a subassembly for a freewheeling clutch according to the invention comprising a cage, the inserted band spring according to FIG. 7 and clamping bodies mounted therein;

FIG. 9 shows a perspective view of a cage for a freewheeling clutch, which, however, does not have any empty pockets;

FIG. 10 shows a perspective view of a further cage for a freewheeling clutch, which has been modified in relation to FIG. 9;

FIG. 11 shows the side view of a subassembly for a freewheeling clutch, and FIG. 12 shows an end view of the subassembly according to FIG. 11.

### DETAILED DESCRIPTION OF EMBODIMENTS OF THE INVENTION

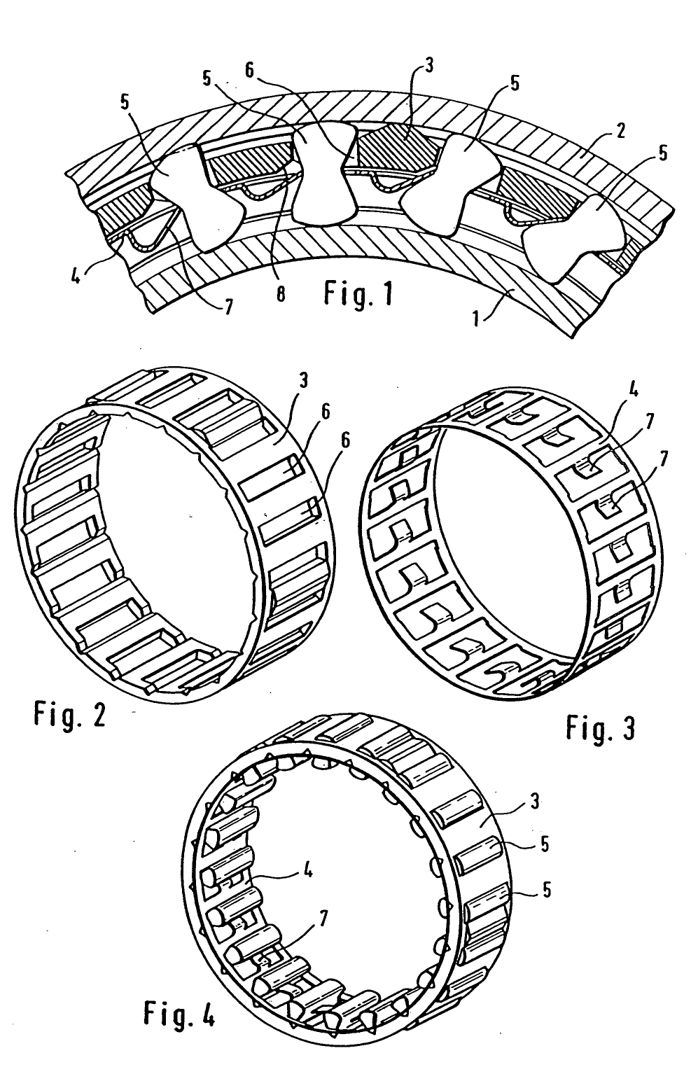

An older prior art freewheeling clutch illustrated in FIGS. 1 to 4 consists of a circular cylindrical inner ring 1, an outer ring 2 surrounding the inner ring 1 concentrically at a spacing and a subassembly comprising a cage 3, a band spring 4 and a number of clamping bodies 5 arranged in the spacing. Through-pockets 6 for receiving the clamping bodies 5 are machined in the cage 3 one behind the other at equal spacings in the circumferential direction.

The band spring 4 is of annular design and is produced from a punched-out steel band. Corresponding to the pockets 6 of the cage 3, the spring 4 has punched cutouts arranged one behind another at spacings in the circumferential direction. A spring tongue 7 was excluded from the punching operation and is arranged in each punched cutout. The band spring 4 is dimensioned such that it can be inserted axially into the cage 3 and bears against the inner surface of the cage 3. In this connection, the spring tongues 7 of the band spring 4 project into the areas of the pockets 6 of the cage 3.

The clamping bodies 5 can then be inserted radially from outside into the pockets 6 of the cage 3 and into the punched cutouts of the band spring 4. The bodies 5 are then held, in the circumferential direction of the cage 3, on one side by the spring tongues 7 and on the other side by webs of the band spring 4. A delimiting wall 8 within each of the pockets 6 for receiving a clamping body 5 is in the form of a bevel, which makes it possible for the respective spring tongue 7 to bear against the cage 3 over a surface.

In FIG. 1, the clamping bodies 5 are illustrated in four different positions, which positions follow one another during operation. The clamping body 5 on the outside on the left is located in the position with the maximum clamping action between the inner ring 1 and the outer ring 2, while the clamping body 5 on the outside on the right is located in the lifted-off position and holds the adjacent spring tongue 7 of the band spring 4 against the delimiting wall 8. The other two clamping bodies are in positions intermediate the end positions.

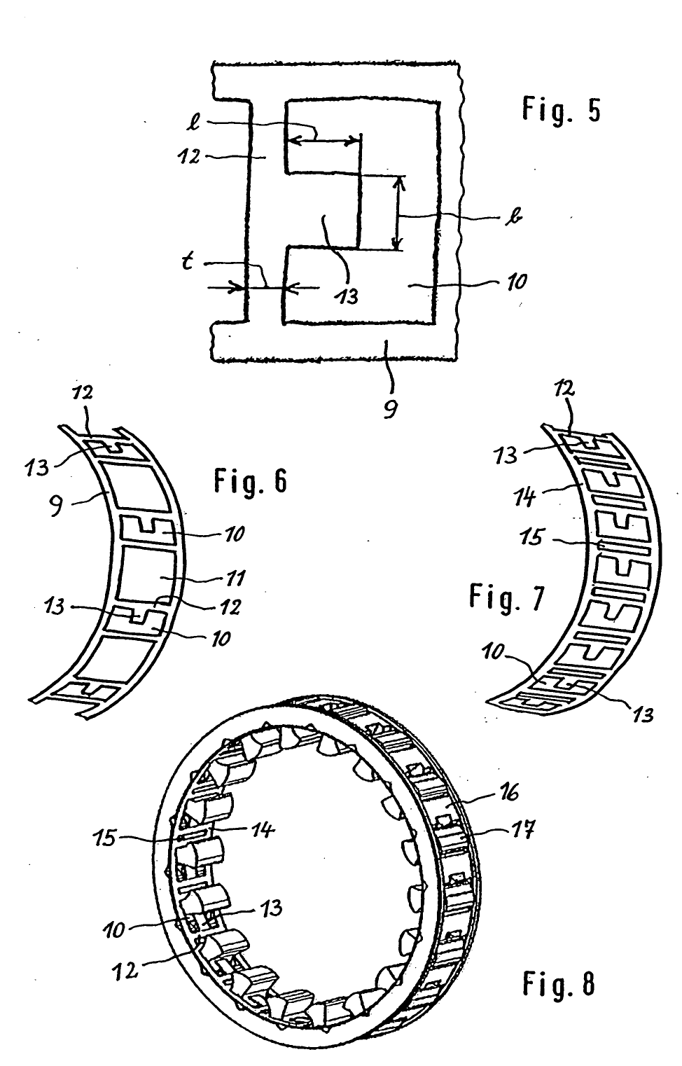

The band spring 9 for a freewheeling clutch according to the invention illustrated in FIGS. 5 and 6 differs from the prior art band spring 4 according to FIG. 3 in that in each case an empty pocket 11 follows a punched cutout 10 in the circumferential direction, a spring web 12 extending in an axially parallel manner of the annular band spring 9 being located between the punched cutout 10 and the empty pocket 11. Each spring web 12 is in one piece with a spring tongue 13. This tongue projects into the area of the associated punched cutout 10, its length l adjoining in the circumferential direction the width t of the spring web 12. In the elevation, the spring tongue 13 is rectangular and has a width b in the axially parallel direction of the annular band spring 9.

It applies generally that the length l of the spring tongue 13 follows geometrically from the movement of the clamping body used between its lifting-off and its transmission position for the maximum torque arising. The length l is to be selected to be as short as possible in order that the freewheel can be fitted with a maximum number of clamping bodies. The width b of the spring tongue 13 can be varied as required within the limit of the width of the punched cutout 10. The web width t of the spring web 12 is to be as small as possible in order that by virtue of this as well as many clamping bodies as possible can be fitted into the freewheel. With different fitting of the freewheel with clamping bodies, the length l and the width b of the spring tongue 13 can be retained without further action. However, the web width t must be varied corresponding to the number of clamping bodies or corresponding to the diameter of the freewheel.

In order nevertheless to obtain an optimally matched geometry of the band spring 9, which is determined by the length l of the spring tongue 13, the width b of the spring tongue 13 and also the web width t of the spring web 12, the empty pockets 11 are according to the invention provided on the band spring 9. In this way, the same spring dimensions can be retained for clamping bodies of the same geometrical shape in any fitting arrangement and for different freewheel diameters. The empty pockets 11 of a band spring 9 can also be distributed asymmetrically or be different in size. The cage to be used in the freewheeling clutch can be matched to the empty pockets 11. It can also be provided with pockets for receiving clamping bodies only in the regions of the punched cutouts 10 and of the spring tongues 13 of the band spring 9.

The band spring 14 according to FIG. 7 is in principle designed in the same way as the band spring 9, but its empty pockets 15 have a smaller dimension in the circumferential direction. It is fitted in the subassembly for a freewheeling clutch shown in FIG. 8 with a cage 16 and clamping bodies 17 arranged therein.

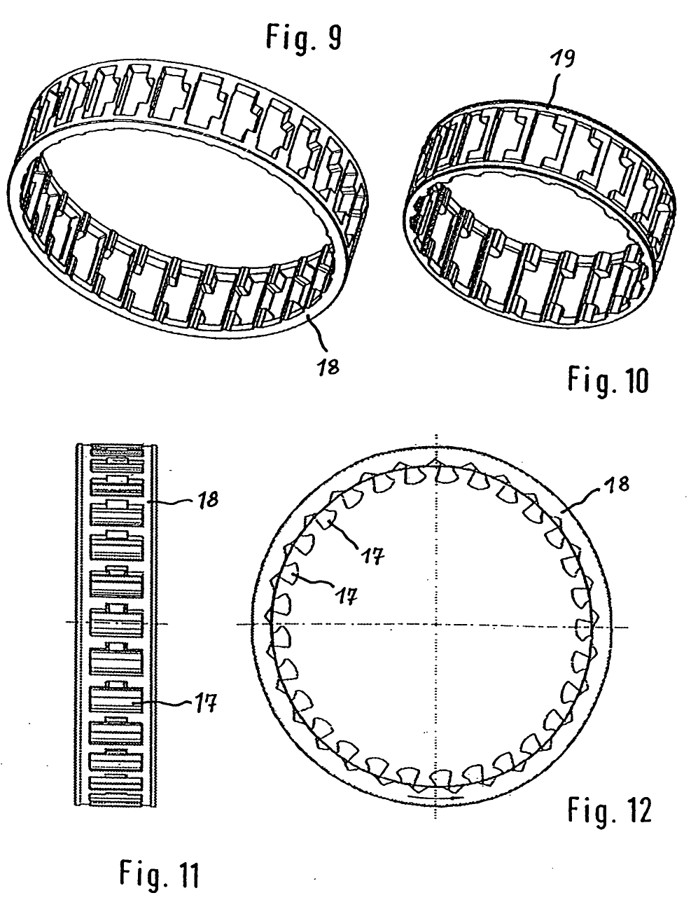

The subassembly for a freewheel illustrated in FIGS. 9, 11 and 12 consists of only three different parts with symmetrical geometry. Synchronization of the movement of the clamping bodies 17 is achieved even without a double cage. A high degree of fitting with clamping bodies 17 can be achieved over the circumference as the spring tongue extends into the waisting of the clamping body. All masses are distributed concentrically to the outer clamping path as the cage 18 or 19 is guided in it, the spring band is guided in the cage and the clamping bodies 17 are in turn guided in the spring band. Uniform springing of the clamping bodies 17 is associated with this. One of the major cost advantages is the possibility of automatically inserting all the clamping bodies 17 simultaneously and in less than a second radially from outside into the cage 18, 19 provided with inserted spring band by means of a “total filling head”. Mechanical sortability of clamping body geometry is possible. The functionally ideal clamping body geometry can be integrated into the freewheel concept elaborated without change or reworking.

In the total freewheel concept according to the invention, the clamping body geometry can be designed completely freely and thus entirely optimally in terms of functioning. For clear positioning of the spring and thus of the clamping body in the cage, geared to the mountability between the clamping paths, all that is necessary is an exactly defined waisting of the clamping body.

A glass-fiber-reinforced plastic (PA46GF, PA66GF or PPS), such as is already state of the art in rolling bearings in the automotive sector, is intended as the material for the cage. This has the advantage of low material costs and also of advantageous and economical manufacture in large quantities using an injection-molding tool. Such a very expensive tool usually pays for itself in automobile construction through quantity and operational life. The low mass of plastic and the associated low inertia are also convincing arguments in its favor. Glass fiber contents increase strength and wear resistance. Modern plastics have a temperature stability of up to 200° C. (PPS) and very good chemical compatibility with common automobile oils. A low coefficient of friction in relation to steel brings about positive wear and friction behavior of clamping bodies, spring and clamping paths.

As what are known as cage pockets, the cage has cutouts of radially T-shaped design, which are distributed evenly in the circumferential direction. The part area of the larger rectangular cutout serves for receiving the clamping bodies and also for their symmetrical distribution in the circumferential direction. Here, each clamping body is guided in an axially parallel manner and axially. It is designed in such a way that its free movement is always possible. The part area of the smaller rectangular cutout allows unhindered and collision-free movement of the rigid spring tongue.

Bearing slopes on the inside diameter of the cage form a positive end stop for each individual clamping body under the influence of centrifugal force when the clamping bodies have lost the contact with the inner clamping path. By virtue of this, the lift-off travel of the clamping bodies is limited in each case in order that these enter into frictionally engaged contact with the inner clamping path again as quickly as possible, when the centrifugal force decreases, owing to the opposing springing force. The spring deflection and stresses in the spring caused by it are likewise limited owing to the end stop.

Radial guidance of the slightly outwardly preloaded spring band takes place on the smallest inside diameter of the cage. At the same time, this diameter prevents expansion of the open spring band under the influence of centrifugal force. The abutting ends of the spring band are not interconnected.

A cage rim prevents the spring band projecting axially from the cage and also axial contact of clamping bodies and a sliding disk mounted on the cage, if such a disk has to be present.

The entire cage is guided on the outside, that is the play between the outside diameter of the cage and the outer clamping path—taking the different thermal expansions into account—is designed to be as small as possible. By virtue of this, the radial component of the centrifugal force acting on the clamping body can be conveyed through the cage ideally directly to the outer clamping path. The cage is thus relieved. The friction between the cage and the outer clamping path, which is increased in this way under centrifugal force, favors the corotation of clamping bodies and cage, so that these can achieve the same rotational speed as the outer clamping path.

In connection with the need for one or two sliding disks, grooves running around on one side or both sides in the circumferential direction can be designed on the cage. These then make it possible for axially snapped-on sliding disks to be received in a twist-free and at the same time transport-secure way. The snapping-on is effected by means of partial beads on the sliding disks. The external guidance of the cage then takes place via radial protuberances on the outside diameter of the cage in the region of the cage webs above the bearing slopes.

This cage construction results in a symmetrical geometry. The clamping direction of the freewheel can be indicated by means of an inscription on the sliding disk or a marking on the cage.

The spring consists of a one-piece spring steel band, which springs each clamping body individually. The geometry is simple, one-dimensional and linear, without any kind of bend. The only possible settling behavior is the expansion of the spring band, but this is prevented by means of guidance on the inside diameter of the cage. The band can be manufactured as a simple punched or laser-cut part.

The entire spring band can be rolled as a unit, including the spring tongues. This results in uniform springing properties in the assembly for the first and last clamping body and all the clamping bodies lying in between. The spring band is inserted into the cage with slight radial preloading and is positioned concentrically by it in a defined way.

The clearance of the spring tongue to the spring web, in which the clamping body is received in a transport-secure manner and is retained in an axially parallel manner, must correspond at least to the narrowest place on the clamping body (waisting). Only in this way is free and undisturbed movement of the clamping body in the spring pocket possible, in particular when the steel spring tongue passes through its zero position, that is when the direction of the springing force changes from radially outward to radially inward or vice versa.

The clearance of the spring tongue described above is for transport of the freewheel located exactly in the clamping body waisting, to which the inside diameter of the cage must of course be matched. The springing thus becomes effective only when mounting in the connection parts takes place. The nature of the springing supports the frictional engagement of the clamping bodies with the clamping paths at the beginning of torque take-up and at the same time the rolling-in movement of the clamping bodies resulting from the torque. In the course of torque build-up, the springing force changes its direction on passing through the zero position. It subsequently favors the release of the clamping body when the torque falls again. This version of the springing thus counteracts the inertia of the clamping bodies at high load frequencies.

For dynamic applications, a cage is always provided for supporting the clamping bodies acted on by centrifugal force and also the open spring band. In the case of static loads without rotational speeds, on the other hand, a closed spring band without a cage is conceivable. For this purpose, the abutting ends of the rolled spring band can be interconnected, by laser welding for example. The concentric positioning of the spring band thus closed then takes place via the clamping body waisting.

Owing to the continuous, one-piece spring band and in particular its relatively great spring stiffness in the circumferential direction, synchronization of the clamping body movement is achieved. The synchronization results in one circumferential direction from the contact with the spring tongue and in the other circumferential direction from the contact with the spring web. On account of the spring preloading, the synchronization is tolerance-independent and play-free. For the same reason, the slipping-through of an individual clamping body does not automatically have effects on the remaining clamping bodies, as is the case with the double cage principle.

The spring tongue subjected to bending stress is so rigid in relation to the spring web subjected to torsional load that the spring action results from the torsion of the spring web alone; spring tongue and spring rim undergo no elastic deformation on account of the springing. The cage must therefore have a clearance in the region of the spring webs. Like the geometry of the cage, the geometry of the spring can be symmetrical in design.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A freewheeling clutch comprising:
a circular cylindrical inner ring and an outer ring concentric to the inner ring;
a cage for clamping bodies and located radially between the rings, the cage having pockets therein;
clamping bodies arranged and spaced one behind another in the circumferential direction between the rings and each being guided in one of the pockets of the cage, each clamping body being of such size and shape and being movable in its cage pocket between a driving orientation at which the clamping body engages the rings to drivingly engage the clutch and a non-driving orientation;
an annular band spring having spring tongues thereon, the tongues bearing radially against the cage, the band spring having punched cutouts arranged one behind another at spacings in the circumferential direction corresponding to the spacings of the pockets of the cage, and the spring tongues are formed by the cutouts; each clamping body also passing through a respective cutout and being engaged by a respective one of the cutouts; and
a respective empty pocket on the band spring circumferentially between two of the punched cutouts arranged one behind another in the circumferential direction.

2. The freewheeling clutch as claimed in claim 1, wherein the empty pocket is a punched opening in the band spring.

3. The freewheeling clutch as claimed in claim 1, comprising a plurality of the empty pockets arranged on the band spring.

4. The freewheeling clutch as claimed in claim 3, wherein one of the empty pockets is assigned to each of the punched cutouts on the band spring,
a spring web holding the spring tongue and being formed between the punched cutout and the empty pocket.

5. The freewheeling clutch as claimed in claim 4, wherein the spring tongue is so placed that upon the respective clamping body moving to the non-driving orientation, the clamping body presses the spring tongue toward the band spring web holding the tongue.

6. The freewheeling clutch as claimed in claim 1, wherein the spring tongue is at a side of the cutout toward which the clamping body moves as it moves toward the non-driving orientation.
